(19) United States
(12) Patent Application Publication
(10) Pub. No.: US 2016/0227141 A1
(43) Pub. Date: Aug. 4, 2016

(54) METHOD OF DRIVING SOLID-STATE IMAGE SENSOR, SOLID STATE IMAGE SENSOR, AND CAMERA

(71) Applicant: CANON KABUSHIKI KAISHA, Tokyo (JP)

(72) Inventors: Hideo Kobayashi, Tokyo (JP); Tetsuya Itano, Sagamihara-shi (JP); Kohichi Nakamura, Kawasaki-shi (JP)

(21) Appl. No.: 15/008,783

(22) Filed: Jan. 28, 2016

(30) Foreign Application Priority Data
Feb. 4, 2015 (JP) 2015-020612

(51) Int. Cl. H04N 5/369; H04N 5/3745; H04N 5/378; H04N 5/341

(52) U.S. Cl. CPC H04N 5/3698; H04N 5/341; H04N 5/37452; H04N 5/378

(57) ABSTRACT

A solid-state image sensor includes a pixel array having pixels, an AD converter configured to generate digital signals by AD-converting analog signals output from the pixel array, a plurality of memories, and an output line. A horizontal transfer period in which the plurality of memories sequentially output digital signals to the output line includes first and second periods. In the first period, digital signals having a predetermined value are continuously output to the output line from a plurality of first memories out of the plurality of memories. In the second period, the digital signals which have been AD-converted by the AD converter are output to the output line from a plurality of second memories, separate from the plurality of first memories, out of the plurality of memories.

### BACKGROUND OF THE INVENTION

1. Field of the Invention

The present invention relates to a method of driving a solid-state image sensor, a solid-state image sensor, and a camera.

2. Description of the Related Art

Japanese Patent Laid-Open No. 2012-90313 discloses a solid-state image sensor that includes a plurality of AD converters corresponding to respective columns of a pixel array. The solid-state image sensor holds, in a plurality of digital memories, a plurality of digital signals converted by the plurality of AD converters. The digital signals held in the plurality of digital memories are output via a block digital output line and a common digital output line.

In a system including a solid-state image sensor and a processor that processes signals output from the solid-state image sensor, there can be an operation mode in which the processor uses only the signals of some necessary pixels out of all the pixels of the solid-state image sensor. In such an operation mode, when the signals of all the pixels are output from the solid-state image sensor, power consumption by the electric charge/discharge in the signal transmission path inside and outside the solid-state image sensor is high. For example, consider a case in which only some necessary pixels out of all the pixels are used in a system incorporating the solid-state image sensor disclosed in Japanese Patent Laid-Open No. 2012-90313. In this case, when the signals of all the pixels are output from the solid-state image sensor, high power is consumed by the block digital output line and the common digital output line in the solid-state image sensor and by the driving of the output pin of the solid-state image sensor.

### SUMMARY OF THE INVENTION

The present invention provides a technique advantageous in reducing power consumption when signals of some pixels are used out of all the pixels of a solid-state image sensor.

One of aspects of the present invention provides a method of driving a solid-state image sensor that includes a pixel array in which a plurality of pixels configured to generate analog signals based on incident light are two-dimensionally arranged, an AD converter configured to generate digital signals by AD-converting the analog signals output from the pixel array, a plurality of memories, and an output line, wherein a horizontal transfer period in which the plurality of memories sequentially output digital signals to the output line includes a first period in which digital signals each having a predetermined value and are not the digital signals which have been AD-converted by the AD converter are output to the output line from a plurality of first memories out of the plurality of memories, and a second period in which the digital signals which have been AD-converted by the AD converter are output to the output line from a plurality of second memories, separate from the plurality of first memories, out of the plurality of memories, and in the first period, the digital signal having the predetermined value of one of the plurality of first memories, and the digital signal having the predetermined value of the other one of the plurality of first memories, are sequentially output to the output line.

Further features of the present invention will become apparent from the following description of exemplary embodiments with reference to the attached drawings.

### BRIEF DESCRIPTION OF THE DRAWINGS

FIG. 1 is a view showing the arrangement of a solid-state image sensor according to the first embodiment;

FIG. 2 is a timing chart showing the operation according to the first embodiment;

FIG. 3 is a view showing the first modification of the first embodiment;

FIG. 4 is a view showing the second modification of the first embodiment;

FIG. 5 is a view showing the arrangement of a solid-state image sensor according to the second embodiment;

FIG. 6 is a timing chart showing the operation according to the second embodiment;

FIG. 7 is a view showing the arrangement of a solid-state image sensor according to the third embodiment;

FIG. 8 is a timing chart showing the operation according to the third embodiment;

FIG. 9 is a view showing the arrangement of a solid-state image sensor according to the fourth embodiment; and

FIG. 10 is a block diagram showing the arrangement of a camera according to an embodiment.

### DESCRIPTION OF THE EMBODIMENTS

Exemplary embodiments of the present invention will be described below with reference to the accompanying drawings.

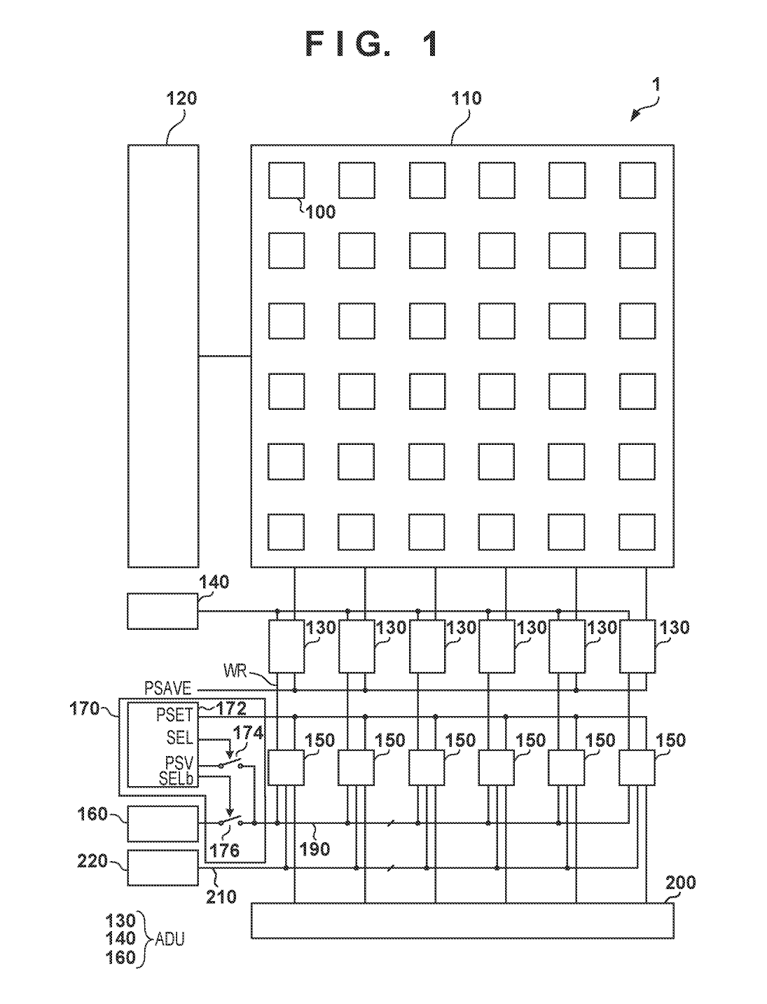

First, a solid-state image sensor 1 according to the first embodiment of the present invention will be described with reference to FIG. 1. The solid-state image sensor 1 can include, for example, a pixel array 110, a vertical selecting unit 120, a plurality of comparators 130, a reference signal generator 140, a plurality of memories 150, a counter 160, a horizontal selecting unit (selecting unit) 200, a horizontal output line (output line) 210, an output unit 220, and a write unit 170. From another point of view, the solid-state image sensor 1 includes an AD converter ADU, and the AD converter ADU can include, for example, the plurality of comparators 130, the reference signal generator 140, and the counter 160. The pixel array 110 includes a plurality of pixels 100 that are two-dimensionally arranged so as to form a plurality of rows and a plurality of columns. Each pixel 100 generates an analog signal based on incident light. The analog signal of each pixel 100 is output via a corresponding column signal line. The pixels 100 that form one column can be connected to each column signal line.

According to the first embodiment, in an operation mode in which the digital signals of all the pixels 100 of the pixel array 110 are output from the solid-state image sensor 1, the AD converter ADU AD-converts all the plurality of analog signals output from the pixel array 110 to generate the digital signals. On the other hand, in an operation mode in which the digital signals of some of the pixels 100 out of all the pixels 100 of the pixel array 110 are output from the solid-state image sensor 1, the AD converter ADU AD-converts some of the plurality of analog signals output from the pixel array 110 to generate the digital signals.

In the AD converter ADU, the reference signal generator 140 generates a reference signal (for example, a ramp signal) which changes with elapsed time. Each comparator 130 compares the value of the reference signal generated by the reference signal generator 140 and the value of each analog signal output from the pixel array 110 (pixels 100) and outputs a write control signal WR (for example, a pulse signal) when, for example, the magnitude relationship of the two signal values is inverted. The counter 160 generates a count value in accordance with the elapsed time and outputs the generated count value to a data line 190. The write control signal WR output by each comparator 130 is a signal indicating the timing to write the count value generated by the counter 160 in the corresponding memory 150.

In another mode, the counter 160 can be provided for each comparator 130. The comparator 130 is provided for each column (a column formed by the pixels 100) of the pixel array 110. The AD converter ADU can be understood as a set of a plurality of AD converters corresponding to the respective columns of the pixel array 110. In the example shown in FIG. 1, one AD converter includes one comparator 130, and the reference signal generator 140 and the counter 160 are shared by the plurality of AD converters. The plurality of memories 150 hold the digital signals generated by the AD converter ADU.

The horizontal selecting unit (selecting unit) 200 sequentially selects the plurality of memories 150 to cause the horizontal output line 210 to sequentially output the plurality of digital signals held in the plurality of memories 150.

To cause digital signals each having a predetermined value to be output to the horizontal output line 210 from a plurality of first memories 150 out of the plurality of memories 150, the write unit 170 writes a digital signal PSV having a predetermined value in each of the plurality of first memories 150 of the plurality of memories 150. The write unit 170 writes the digital signals PSV each having the predetermined value in the plurality of the first memories 150 so that the digital signals PSV each having the predetermined value will be sequentially output to the output line 210 from at least two of the first memories 150 of the plurality of first memories 150. Each predetermined value is, for example, is a constant value in which all bits are either “0s” or “1s” or a constant value consisting of a combination of “0s” and “1s”. The write unit 170 writes each digital signal PSV in the corresponding memory 150 before the signal is output from the memory 150 to the horizontal output line 210. In other words, the writing of each digital signal PSV by the write unit 170 is controlled so that the digital signal PSV is output to the horizontal output line 210 from the corresponding memory 150 in which the write unit 170 has written the digital signal PSV.

The write unit 170 includes, for example, a write control unit 172 and switches 174 and 176. The write control unit 172 outputs a write control signal PSET, selection signals SEL and SELb, and the digital signal PSV. The selection signals SEL and SELb are signals of opposite logic levels. That is, when the selection signal SEL is at high level, the selection signal SELb is at low level. When the selection signal SEL is at low level, the selection signal SELb is at high level. In this example, when the selection signal SEL is at high level, the digital signals PSV each having the predetermined value are supplied to the memories 150 via the data line 190, and when the selection signal is at low level, the count value of the counter 160 is supplied to each memory 150 via the data line 190. If the write control signal PSET is set to active level (high level) in a state in which the selection signal SEL is at high level, the digital signals PSV each having the predetermined value are written in the memories 150 via the data line 190. If the write control signal WR is output from each comparator 130 in a state in which the selection signal SEL is at low level, a count value of the counter 160, as the AD converted digital signal, is written in each memory 150 via the data line 190 in accordance with the output.

A readout unit (not shown) can be provided between the pixel array 110 and the AD converter ADU. The readout unit can include, for example, a plurality of amplifiers that amplify the signals output from the pixel array 110. The amplifier can be provided, for example, for each column of the pixel array 110.

In the solid-state image sensor 1 exemplified in FIG. 1, some of the plurality of comparators 130 (AD converters), specifically, the first, second, fifth, and sixth column comparators have the power-save mode, and these comparators are set to the power-save mode when a power-save signal PSAVE is set to active level. Note that the example is for explanatory convenience, and the example is applicable to an operation mode that reduces power consumption by setting the comparators 130 of columns other than the columns including the central portion to be set to the power-save mode when reading out the signals of the pixels 100 in the central portion of the pixel array 110. The plurality of comparators 130 all have the power-save mode and whether to set the power-save mode can be individually controlled for each comparator.

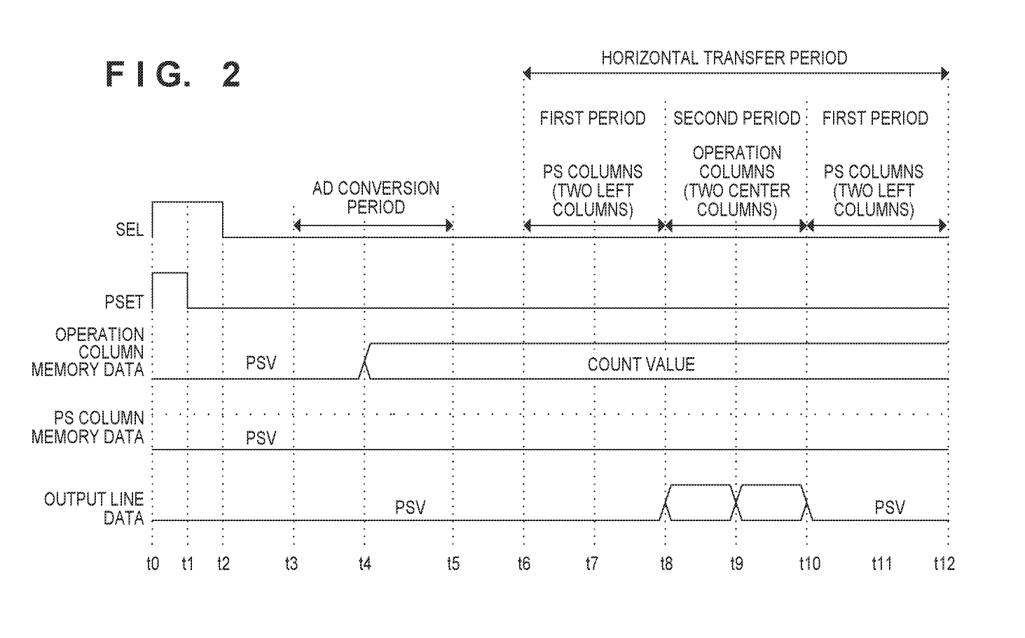

The method of driving the solid-state image sensor 1 when the first, second, fifth, and sixth column comparators 130 are set to the power-save mode, that is, when the power-save signal PSAVE is set to active level will be described below with reference to FIG. 2. In FIG. 2, “PS columns” denote columns (power-save columns) that are set to the power-save mode, “operation columns” denote columns that are not set to the power-save mode.

When the selection signal SEL is driven to high level (selection signal SELb is driven to low level) at time t0, the digital signals PSV each having the predetermined value are output to the data line 190. In this example, each predetermined value is a value in which all bits are “0s”, but can be a value in which all bits are “1s” or it can be an arbitrary value obtained from a combination of “0s” and “1s”. Note that, however, the predetermined value is fixed to a constant value. In the case of the arbitrary value having a combination of “0s” and “1s”, the signal level is to be a level that the signal levels of the plurality of buses included in the horizontal output line 210 can become constant. More specifically, the signal value of a bus that transmits certain bits is set to be constant at “0”, and the signal value of a bus that transmits other bits is set to be constant at “1”. When the write control signal PSET is driven to active level (high level in this case) in addition to the selection signal SEL changing to high level at time t0, the write control unit 170 writes the digital signals PSV in all the memories 150 via the data line 190. That is, the digital signals PSV are written in the memories 150 of the power-save columns and the memories 150 of the operation columns.

The AD conversion period begins from time t3. In the AD conversion period, the comparators 130 (AD converters) compare the values of the analog signals from the pixels 100 with the value of the reference signal supplied from the reference signal generator 140 and output the write control signals WR to the memories 150 in accordance with the comparison result. A count value supplied from the counter 160 via the data line 190 is written in each memory 150 that has received the write control signal WR. In the example of FIG. 2, the count value is written in each memory 150 of the operation columns at time t4. This timing is determined in accordance with the values of the analog signals from the pixels 100. On the other hand, no write control signal WR is output from the comparators 130 (AD converters) that are set to the power-save mode, so the corresponding memories 150 keep holding the digital signals PSV each having the predetermined value even at the time t5 when the AD conversion period ends.

A horizontal transfer period begins from time t6. In the horizontal transfer period, the horizontal selecting unit 200 sequentially selects the plurality of memories 150, signals are output from the selected memories 150 to the output line (horizontal output line) 210, and the signals are output from the output unit 220 to outside the solid-state image sensor 1.

The horizontal transfer period includes the first period and the second period. In the first period, the digital signals PSV each having a predetermined value and are not digital signals which have been AD-converted by the AD converter ADU are output to the output line (horizontal output line) 210 from the plurality of first memories 150 out of the plurality of memories 150. In the first period, the digital signals PSV each having the predetermined value are sequentially output to the output line 210 from at least two first memories out of the plurality of first memories 150. In the second period, digital signals which have been AD-converted by the AD converter ADU and written in a plurality of second memories 150 are output to the output line 210 from the plurality of second memories different from the plurality of first memories out of the plurality of memories 150.

In this example, from time t6 to t8 (a part of the first period), the first memory 150 of the first column and that of the second column are sequentially selected and two digital signals PSV each having the predetermined value are sequentially output to the output line 210. Afterwards, from time t8 to t10, (second period), the first memory 150 of the third column and that of the fourth column are sequentially selected and the digital signals converted from the analog signals from the pixels 100 are sequentially output to the output line 210. Subsequently, from time t10 to t12 (another part of the first period), the first memory 150 of the fifth column and that of the sixth column are sequentially selected and two digital signals PSV each having the predetermined value are sequentially output to the output line 210. In this case, in parts (time t6 to t8, t10 to t12) of the first period, the digital signals PSV each having the predetermined value are sequentially output to the output line 210 and to outside the solid-state image sensor 1. Therefore, the power consumption which accompanies the electric charge/discharge of the load in the signal transmission path can be reduced. On the other hand, if digital signals corresponding to the signals of pixels 100 are written in all the memories 150 and are output to the output line 210, power of an amount corresponding to that is consumed. Although two digital signals PSV each having the predetermined value are sequentially output to the output line 210 in the examples shown in FIGS. 1 and 2, three or more digital signals PSV each having the predetermined value can be sequentially output to the output line 210. The first period can include a period in which only one digital signal PSV which has the predetermined value is output.

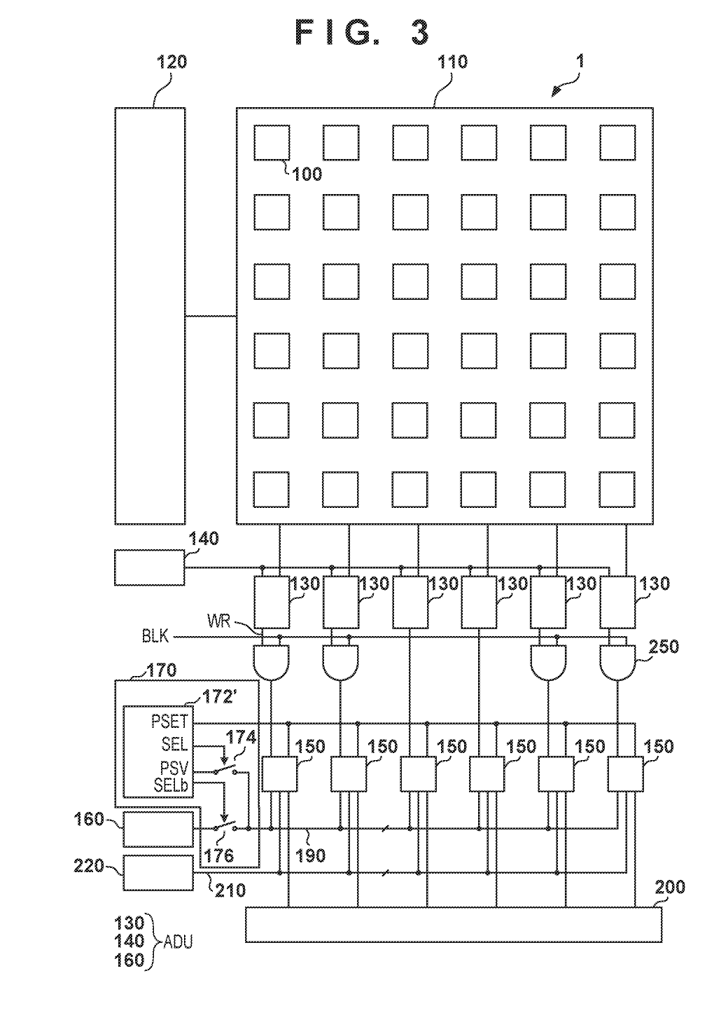

Although the above-described examples show a case in which some of the plurality of comparators 130 (AD converters) are set to the power-save mode, the first embodiment can be applied to other arrangements in which unnecessary signals are not written in the memories 150. FIG. 3 shows the first modification of the first embodiment. In the solid-state sensor 1 of the first modification, in a mode in which only signals of some of the pixels 100 out of all the pixels 100 in the pixel array 110 are used by an external processor, the output from each comparator 130 (AD converter) belonging to a column whose signals are unnecessary is blocked by a corresponding blocking unit 250. Each blocking unit 250 can be formed by, for example, an AND circuit. When a blocking signal BLK is set to active level, each blocking unit 250 blocks the output of corresponding comparator 130 (AD converter), that is, blocks the write control signal WR so the write control signal WR is not supplied to the corresponding memory 150.

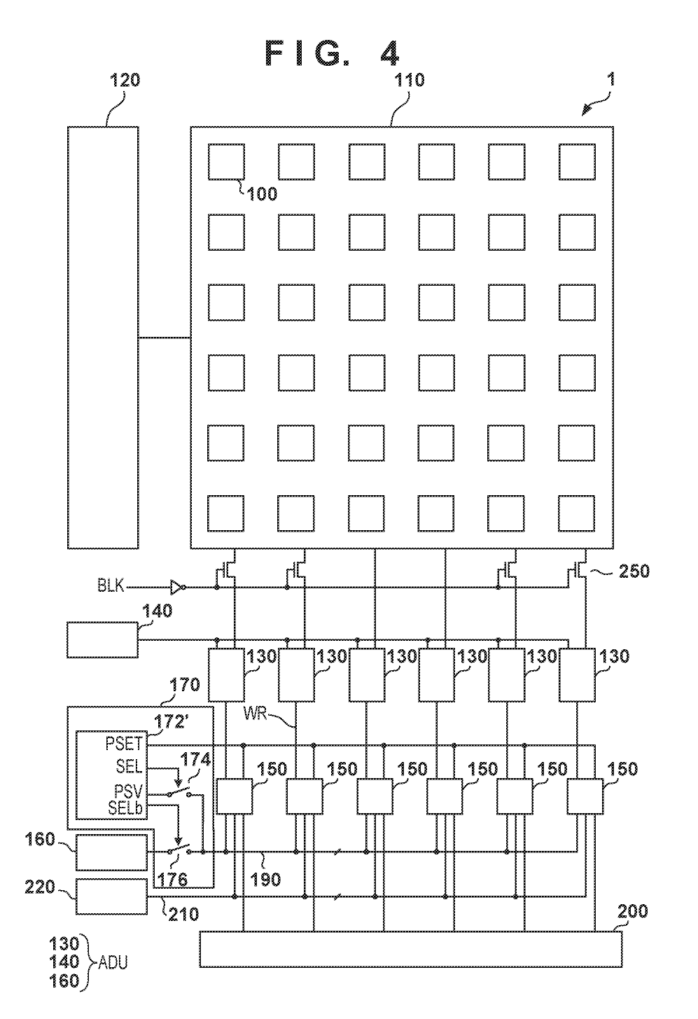

FIG. 4 shows the second modification of the first embodiment. In the solid-state sensor 1 of the second modification, the blocking unit 250 (for example, a path-gate of an MOS transistor or the like) is provided on some of the paths between the pixel array 110 (the column signal lines of the pixel array 110) and the comparators 130. In a mode in which only the signals of some of the pixels 100 out of all the pixels 100 of the pixel array 110 are used by the external processor, inputs to the comparators 130 (AD converters) of columns whose signals are unnecessary are blocked by the blocking units 250. When the blocking signal BLK is set to active level, the blocking units 250 block inputs to the corresponding comparators 130 so signals of the pixels 100 are not supplied to the comparators 130 (AD converters).

The first modification and the second modification are examples of the arrangements of the solid-state image sensor 1 that includes the blocking units 250 for blocking the signal outputs from some of the comparators 130 or inputs to some of the plurality of comparators 130. The write unit 170 writes the digital signals PSV in the memories 150 corresponding to the comparators 130 that have been blocked by the blocking units 250 so that the digital signals PSV are output to the horizontal output line 210 from the memories 150 corresponding to the comparators 130 that have been blocked by the blocking units 250.

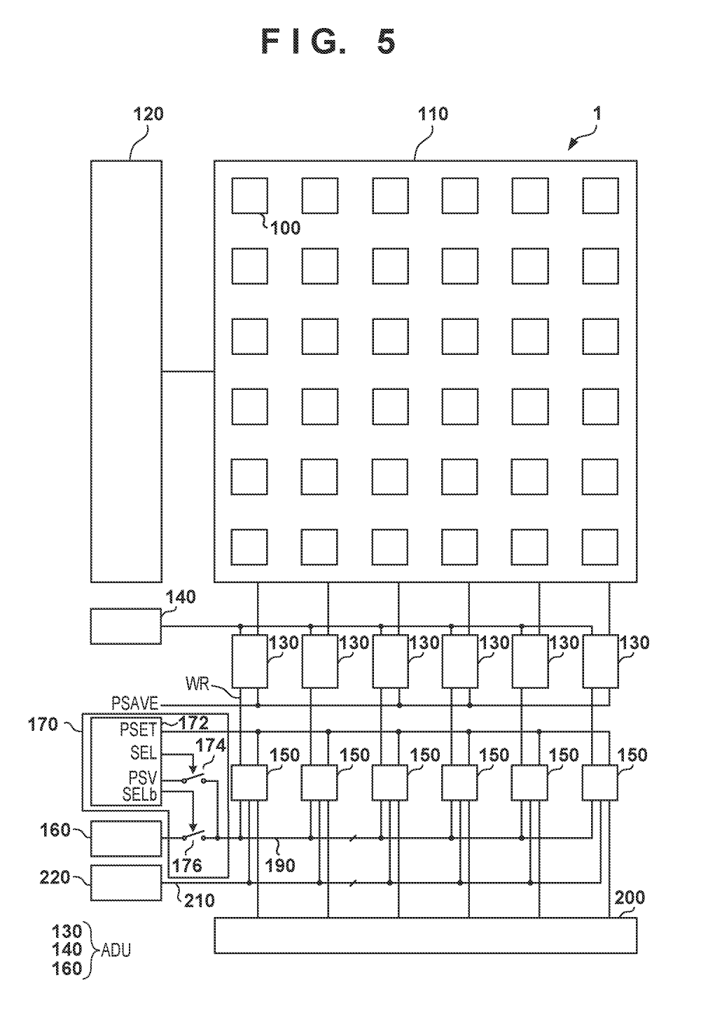

A solid-state image sensor 1 according to the second embodiment of the present invention will be described with reference to FIG. 5. Matters not mentioned in the second embodiment can comply with the first embodiment. The second embodiment provides an operation mode in which a plurality of columns (columns formed by pixels 100) of a pixel array 110 are grouped together on a three-column basis and the columns of each group are arranged in the order of power-save column/operation column/power save column. This operation mode intends to reduce the power consumption by setting comparators 130 (AD converter) which need not operate at the time of thinning out or adding the pixel signals in the horizontal direction to the power-save mode. A power-save signal PSAVE is supplied to each power save column and no power-save signal PSAVE is supplied to each operation column. This operation mode is one example of an operation mode that sets columns which are periodically selected from the plurality of columns forming the pixel array 110 to the power-save mode.

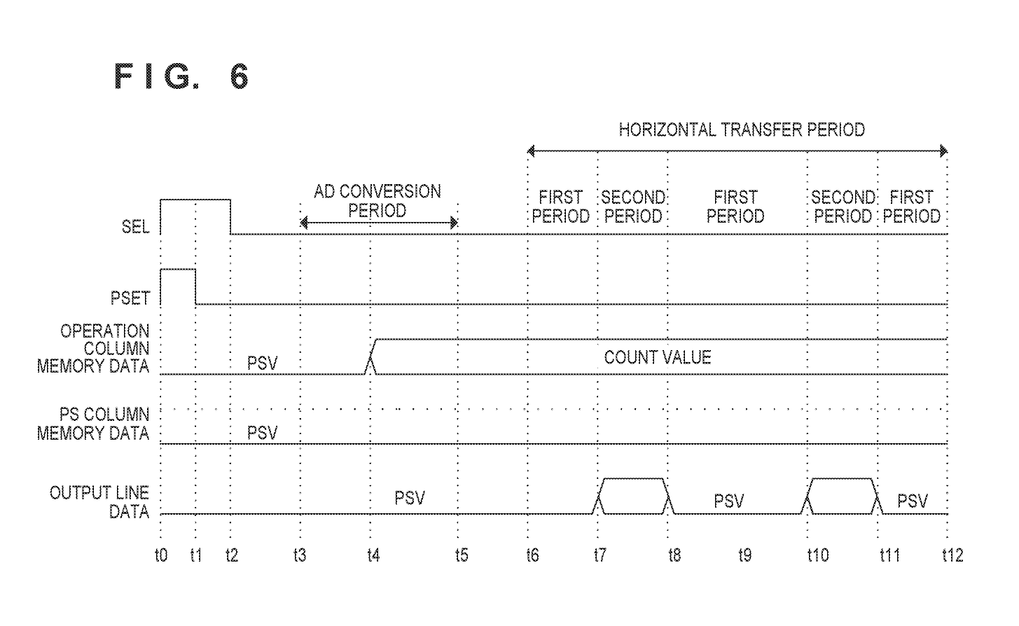

FIG. 6 shows a method of driving the solid-state image sensor 1 according to the second embodiment when the power-save signal PSAVE is set to active level. In the horizontal transfer period from time t6, signals are sequentially output in the order of a predetermined value (PSV), count value (AD-converted digital signal), predetermined value (PSV), predetermined value (PSV), count value (AD-converted digital signal), and predetermined value (PSV). In this case, time t6 to t7, time t8 to t10, time t11 to t12 are parts of the first period and time t7 to t8, time t10 to t11 are parts of the second period. The power consumption is reduced since there is a period (t8 to t10) in which each of the digital signals having a predetermined value (PSV) is output sequentially, in the first period.

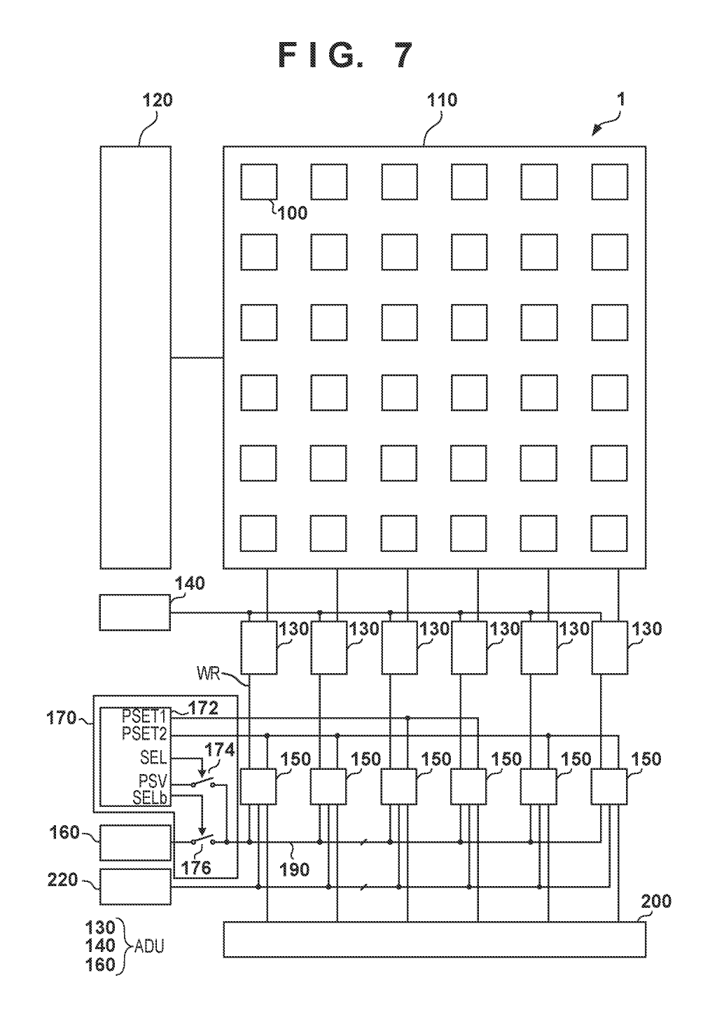

A solid-state image sensor 1 according to the third embodiment of the present invention will be described with reference to FIG. 7. Matters not mentioned in the third embodiment can comply with the first or second embodiment. In the third embodiment, a write control unit 172 generates a first write control signal PSET1 and a second write control signal PSET2. The first write control signal PSET1 is a control signal for writing digital signals PSV each having a predetermined value in memories 150 of columns (readout columns) that output the signals of pixels 100 from the solid-state image sensor 1. The second write control signal PSET2 is a control signal for writing the digital signals PSV each having the predetermined value in the memories 150 of columns (non-readout columns) that do not output the signals of the pixels 100 from the solid-state image sensor 1. In this example, the second write control signal PSET2 is also a control signal for writing the digital signals PSV each having the predetermined value in memories (first memories) 150 of power-save columns. Therefore, the writing of the digital signals PSV in columns (readout columns) that output the signals of the pixels 100 from the solid-state image sensor 1 and in columns (non-readout columns) that do not output the signals can be controlled separately.

In this example, the first write control signal PSET1 controls the writing of the digital signals PSV in the memories (second memories) 150 of the third and fourth columns (readout columns). On the other hand, the second write control signal PSET controls the writing of the digital signals PSV in memories 150 of the first, second, fifth, and sixth columns (non-readout columns).

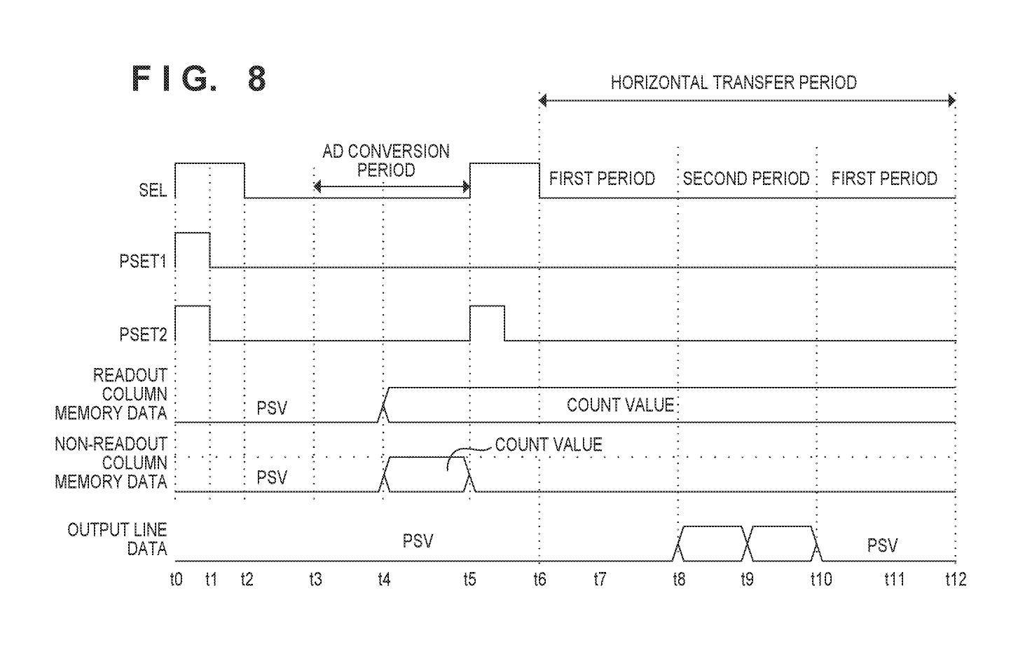

FIG. 8 shows a method of driving the solid-state image sensor 1 according to the third embodiment when the power-save signal PSAVE is set to active level. At time t0, a selection signal SEL, the first write control signal PSET1 and the second write control signal PSET2 are driven to high level, and the digital signals PSV each having the predetermined value are written in the memories 150 of all the columns.

In the AD conversion period starting from time t3, based on the comparison by each comparator 130 (AD converter), each count value corresponding to the analog signals from the pixels 100, that is, each AD-converted digital signal is written in each memory 150 of all the columns. Subsequently, at time t5, when the selection signal SEL and the second write control signal PSET2 are driven to high level, the digital signal PSV which has the predetermined value is written again in the corresponding memory (first memory) 150 of each non-readout column. From the above-described operation, the signals output to a horizontal output line 210 in the horizontal transfer period can be provided in the same manner as in the first embodiment shown in FIG. 2. Therefore, power consumption is also reduced in the third embodiment.

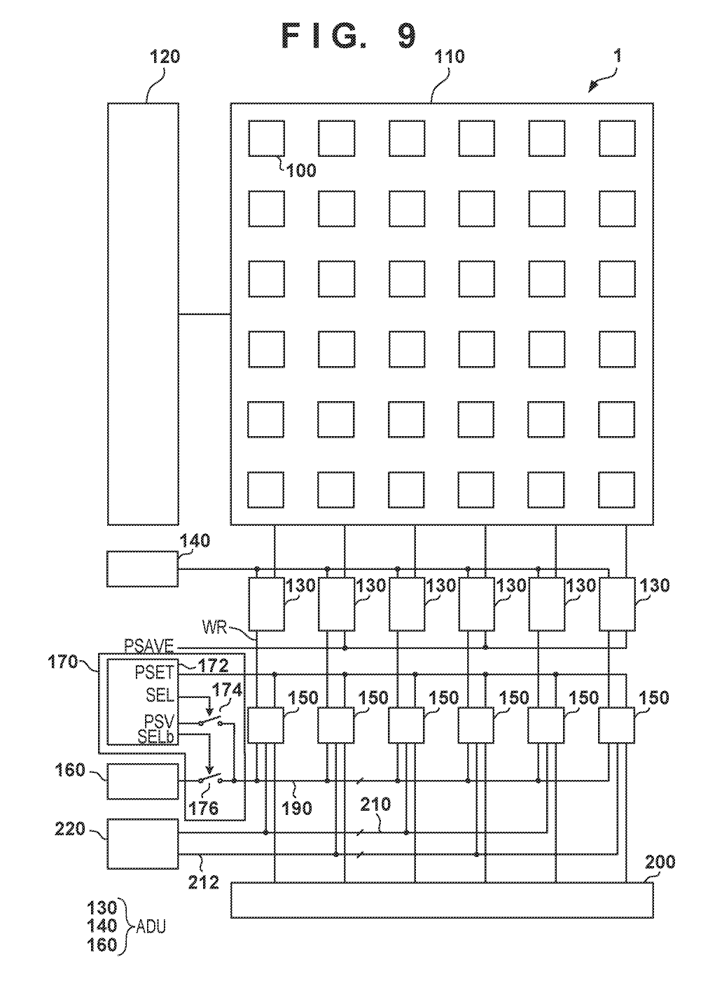

A solid-state image sensor 1 according to the fourth embodiment will be described with reference to FIG. 9. Matters not mentioned in the fourth embodiment can comply with the first, second, or third embodiment unless they contradict. In the fourth embodiment, comparators 130 (AD converters) arranged on even numbered columns are configured to be settable in the power-save mode. In addition, the fourth embodiment includes a first horizontal output line 210 and a second horizontal output line 212 as a plurality of horizontal output lines, and digital signals from a plurality of columns can be distributed and output in parallel to the first horizontal output line 210 and the second horizontal output line 212.

A case when a power-save signal PSAVE is set to active level and the comparators 130 of even numbered columns are set to the power-save mode will be described. In this case, digital signals PSV are written in at least the memories (first memories) 150 of the even numbered columns out of a plurality of memories 150 so that the digital signals PSV each having a predetermined value will be output to the horizontal output line 212 from the memories 150 of the even numbered columns out of the plurality of memories 150. In this example, after the digital signals PSV are written in all the memories 150, only the memories (second memories) 150 of odd numbered columns are overwritten by AD-converted digital signals. Since the digital signals PSV are sequentially output to the horizontal output line 212, the horizontal output line 212 is maintained at a constant level. Therefore, the power consumption which accompanies the electric charge/discharge of the horizontal output line 212 is reduced.

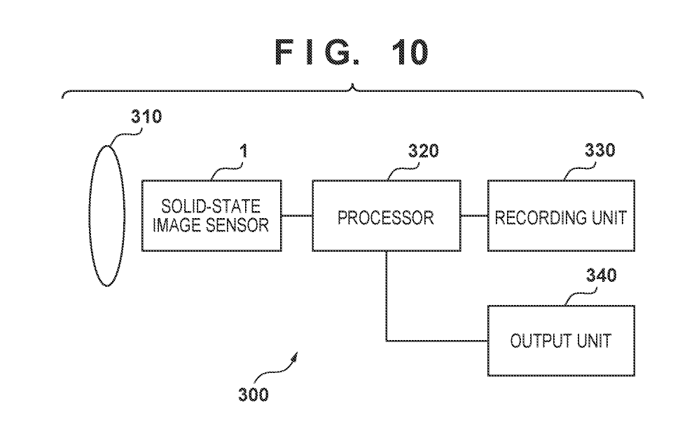

A camera 300 according to an embodiment of the present invention will be described below with reference to FIG. 10. The concept of the camera includes not only apparatuses mainly aiming at shooting but also apparatuses (for example, a personal computer and portable terminal) having an auxiliary shooting function. The camera 300 includes a solid-state image sensor 1 according to the present invention that was exemplified in the above-described embodiments and a processor 320 that processes digital signals output from the solid-state image sensor 1. For example, the processor 320 processes (for example, color processing, compression, or the like) digital signals output from the solid-state image sensor 1. The processor 320 includes, for example, a function to extract and process the signals detected by the solid-state image sensor 1 from the digital signals output from the solid-state image sensor 1. The camera 300 can further include a recording unit 330 and an output unit 340. The recording unit 330 records the digital signals processed by the processor 320 in a recording medium. The output unit 340 includes, for example, at least one of a display unit and a communication unit and outputs signals such as the digital signals processed by the processor 320. The processor 320 can be formed by, for example, a PLD (Programmable Logic Device) such as an FPGA (Field Programmable Gate Array), an ASIC (Application Specific Integrated Circuit), a computer incorporating a program, or a device that is a combination of some or all these components.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-020612, filed Feb. 4, 2015, which is hereby incorporated by reference herein in its entirety.

What is claimed is:

1. A method of driving a solid-state image sensor that includes a pixel array in which a plurality of pixels configured to generate analog signals based on incident light are two-dimensionally arranged, an AD converter configured to generate digital signals by AD-converting the analog signals output from the pixel array, a plurality of memories, and an output line,
wherein a horizontal transfer period in which the plurality of memories sequentially output digital signals to the output line includes
a first period in which digital signals each having a predetermined value and are not the digital signals which have been AD-converted by the AD converter are output to the output line from a plurality of first memories out of the plurality of memories, and
a second period in which the digital signals which have been AD-converted by the AD converter are output to the output line from a plurality of second memories, separate from the plurality of first memories, out of the plurality of memories, and
in the first period, the digital signal having the predetermined value of one of the plurality of first memories, and the digital signal having the predetermined value of the other one of the plurality of first memories, are sequentially output to the output line.

2. The method according to claim 1, wherein the AD converter includes a plurality of comparators configured to compare a value of a reference signal which changes with elapsed time and the values of the plurality of analog signals output from the pixel array, and a counter configured to generate a count value in accordance with the elapsed time.

3. The method according to claim 2, wherein the plurality of first memories are memories corresponding to comparators which have been set to a power-save mode out of the plurality of comparators.

4. The method according to claim 2, wherein the solid-state image sensor further includes a blocking unit configured to block outputs from some of the plurality of comparators or inputs to some of the plurality of comparators, and
the plurality of first memories are memories corresponding to comparators that have been blocked by the blocking unit.

5. The method according to claim 1, wherein the AD converter includes a plurality of AD converters, and
the plurality of first memories are memories corresponding to the AD converters set to a power-save mode out of the plurality of AD converters.

6. The method according to claim 1, wherein the AD converter includes a plurality of AD converters, and the solid-state image sensor further includes a blocking unit configured to block inputs to some of the plurality of AD converters or outputs from some of the plurality of AD converters, and
the plurality of first memories are memories corresponding to the AD converters that have been blocked by the blocking unit.

7. The method according to claim 1, wherein the digital signals each having the predetermined value are written in all of the plurality of memories before the AD converter performs AD conversion, and
the AD converter AD-converts some of the plurality of analog signals output from the pixel array and the digital signals thereby generated are written in the plurality of second memories out of the plurality of memories.

8. The method according to claim 1, wherein the digital signals each having the predetermined value are written in the plurality of first memories out of the plurality of memories after the plurality of digital signals generated by the AD converter are written in the plurality of second memories out of the plurality of memories.

9. The method according to claim 8, wherein the digital signals each having the predetermined value are written in all of the plurality of memories before the AD converter performs AD conversion.

10. The method according to claim 1, wherein a plurality of digital signals held in the plurality of memories are distributed and output to a plurality of output lines which include the output line.

11. A solid-state image sensor comprising:
a pixel array in which a plurality of pixels configured to generate analog signals based on incident light are two-dimensionally arranged;
an AD converter configured to generate digital signals by AD-converting the analog signals output from the pixel array;
a plurality of memories;
an output line; and
a write unit configured to write the digital signals in the plurality of memories;
wherein the write unit performs writing in the plurality of memories so that a horizontal transfer period in which the plurality of memories sequentially output the digital signals to the output line includes a first period in which digital signals, each having a predetermined value and are not the digital signals which have been AD-converted by the AD converter, are output to the output line from a plurality of first memories out of the plurality of memories and a second period in which the digital signals, which have been AD-converted by the AD converter, are output to the output line from a plurality of second memories, separate from the plurality of first memories, out of the plurality of memories, and
in the first period, the digital signal having the predetermined value of one of the plurality of first memories, and the digital signal having the predetermined value of the other one of the plurality of first memories, are sequentially output to the output line.

12. A camera comprising:
a solid-state image sensor, and
a processor configured to process a signal output from the solid-state image sensor,
the solid-state image sensor comprising:
a pixel array in which a plurality of pixels configured to generate analog signals based on incident light are two-dimensionally arranged;
an AD converter configured to generate digital signals by AD-converting the analog signals output from the pixel array;
a plurality of memories;
an output line; and
a write unit configured to write the digital signals in the plurality of memories;
wherein the write unit performs writing in the plurality of memories so that a horizontal transfer period in which the plurality of memories sequentially output the digital signals to the output line includes a first period in which digital signals, each having a predetermined value and are not the digital signals which have been AD-converted by the AD converter, are output to the output line from a plurality of first memories out of the plurality of memories and a second period in which the digital signals, which have been AD-converted by the AD converter, are output to the output line from a plurality of second memories, separate from the plurality of first memories, out of the plurality of memories, and
in the first period, the digital signal having the predetermined value of one of the plurality of first memories, and the digital signal having the predetermined value of the other one of the plurality of first memories, are sequentially output to the output line.
